(19) United States
(12) Patent Application Publication
(10) Pub. No.: US 2020/0216928 A1
(43) Pub. Date: Jul. 9, 2020

(54) RECYCLING METAL-RICH FINES AND POWDER COATING WASTE MATERIAL IN COMPOSITE BRIQUETTES

(71) Applicant: VITO NV (VLAAMSE INSTELLING VOOR TECHNOLOGISCH ONDERZOEK NV), Mol (BE)

(72) Inventors: Kris BROOS, Mol (BE); Philippe BIERCKX, Mol (BE); Peter NIELSEN, Mol (BE); Mieke QUAGHEBEUR, Mol (BE); Jeroen SPOOREN, Mol (BE)

(21) Appl. No.: 16/470,878

(22) PCT Filed: Dec. 22, 2017
(86) PCT No.: PCT/EP2017/084563

§ 371 Date: Jun. 18, 2019

(30) Foreign Application Priority Data
Dec. 23, 2016 (EP) 16206855.5

(51) Int. Cl. C22B 1/244; C08K 11/00; C08J 3/20

(52) U.S. Cl. CPC C22B 1/244; C08J 3/203; C08K 11/005

(57) ABSTRACT

A method of making a composite compact or briquette may include mixing a first particulate material with at most 15% by weight of a powder coating material to obtain a mixture, and compacting the mixture into a compact. Either the first particulate material, the powder coating material, or both are advantageously waste materials. The first particulate material has a metal content of at least 50% by weight. The compact can be cured at temperatures between 50° C. and 300° C. to obtain the composite briquette. The composite briquette may include a binding phase formed of the cured waste powder coating material, and a dispersed phase formed of the first particulate. The composite briquettes can be used as a secondary ore material.

### FIELD

The present disclosure relates to recycling metal-rich particulate materials, in particular waste materials, and converting them to secondary ore materials.

### BACKGROUND

Metal-rich fines and dusts, which arise as a by-product in several metalworking processes, cannot be recycled as such for the production of new metals. The direct introduction of these fine materials into a smelting oven is not considered because of the danger of dust explosions. Therefore, these fines are captured in so called briquettes/compacts before they are introduced into a smelting oven for recycling. It is known from e.g. FR 2795400 to Technologica San, 29 Dec. 2000, to add a hydraulic binder, such as Portland cement, to the fines and compacting the mixture into a briquette. The briquette can be used as a secondary ore material in the smelting oven. A drawback of this procedure is that the hydraulic binder forms an added amount of slag in the smelting oven. Furthermore, Portland cement is a high energy-intensive material and has a high carbon footprint, which makes the recycling of the metal-rich fines and dusts less interesting from an environmental perspective. Moreover, hydraulic binders consume water and need a relatively long hardening time (7-28 days).

It is known from EP 2662457 to Siemens VAI Metals Technologies GmbH, 13 Nov. 2013, to prepare iron-containing agglomerates by producing a mixture comprising finest-grained concentrates and binder, agglomerating the mixture in an agglomeration step, optionally with the addition of water to obtain agglomerates and hardening the agglomerates by subsequent heat treatment at a temperature of 500-1200° C. Carbonaceous material is introduced into the mixture prior to the agglomeration step. The binder can be a synthetic polymer, such as polyvinyl acetate, polyethylene or acrylates. A drawback of the above process is that the high temperatures of heat treatment require a significant amount of energy, increasing the cost and environmental impact of the agglomerates.

### SUMMARY

It is an aim to recycle metal-rich fines and dusts as secondary ore materials in a manner which is less impacting from an environmental perspective. It is an aim to recycle metal-rich fines and dusts as secondary ore materials in a manner which is less energy-intensive than the prior art. It is also an aim to recycle metal-rich fines and dusts as secondary ore materials in a more economical way.

According to first aspects of the disclosure, there is therefore provided a method of making a composite compact or briquette, as set out in the appended claims, wherein waste powder coating materials are used to bind the metal-rich particulate materials into compacts or briquettes. Methods according to these aspects comprise mixing a first particulate material with at most 15% by weight of a powder coating material to obtain a mixture, and compacting the mixture into a compact. Either the first particulate material, the powder coating material, or both are advantageously waste materials. According to first aspects, the first particulate material has a metal content of at least 50% by weight. The compacting step may comprise a shaping step, wherein the mixture is moulded to a desired shape or form. The mixture may be compacted, e.g. in the mould, advantageously with a compaction pressure of at least 1 MPa, at least 2.5 MPa, at least 5 MPa.

Optionally, the compact may be cured. That is, powder coating polymers present in the waste powder coating material are cured or hardened. Typical curing temperatures will be between 50° C. and 300° C. Curing is advantageously performed at temperatures above the melting point of the powder coating polymers. The powder coating particles melt and will form a binding phase intermediate (i.e., between) particles of the first particulate material, which then forms the dispersed phase. Composite briquettes are so obtained.

According to second aspects, there is therefore provided a composite briquette, as set out in the appended claims. The composite briquette is obtainable through methods of the first aspects above, and comprises a binding phase formed of a cured powder coating material or a waste material thereof, and a dispersed phase formed of a particulate material having a metal content of at least 50% by weight. The binding phase amounts to at most 15% by weight.

According to third aspects, there is therefore provided a use of the compact, or the composite briquette as obtained or obtainable via the methods of the first aspects, or the composite briquette of the second aspects, as a secondary ore material, as set out in the appended claims. Third aspects therefore provide for methods in which the compact or composite briquettes as obtained through first aspects, or as in the second aspects are used as secondary ore material in the production of metals. By way of example, the compacts or composite briquettes are introduced in a smelting oven.

The above aspects of the present disclosure allow for recycling one or more particulate materials, in an economical and efficient manner. These particulate materials would otherwise be difficult to dispose of. Particularly advantageously, above aspects allow for obtaining a secondary ore material which is exclusively made up of waste materials. No fresh resources are advantageously used in making the compacts or briquettes. Aspects of the present disclosure therefore allow a more environment-friendly recycling of waste or side streams.

### DESCRIPTION OF THE DRAWINGS

Aspects of the disclosure will now be described in more detail with reference to the appended drawings, which are illustrative, and wherein same reference numerals illustrate same or similar features.

FIG. 1 represents the particle size distribution of polyester powder coating waste material as used in particular embodiments of the present disclosure. The particle size distribution was determined by laser diffractometry.

FIG. 2 represents the particle size distribution of epoxy-polyester powder coating waste as used in particular embodiments of the present disclosure. The particle size distribution was determined by laser diffractometry.

FIG. 3 represents the particle size distribution of epoxy powder coating waste as used in particular embodiments of the present disclosure. The particle size distribution was determined by laser diffractometry.

FIG. 4 represents compressive strength results of composite briquettes obtained with waste steel blasting grit of two different granulometries (type A and type B) and with addition of different amounts of epoxy-polyester powder coating waste (PCW) material.

FIG. 5 represents a microscopic image of a composite briquette obtained with a mixture of coarse waste blasting grit (90^{th} percentile particle size 1 mm) and 5% by weight epoxy-polyester powder coating waste.

FIG. 6 represents a microscopic image of a composite briquette obtained with a mixture of fine waste blasting grit (90^{th} percentile particle size 250 μm) and 5% by weight epoxy-polyester powder coating waste.

### DETAILED DESCRIPTION

According to aspects described herein, metal-rich dusts or fines are mixed with a powder coating waste material to obtain a mixture.

In the context of the present disclosure, the term “fines” or “dusts” refers to a particulate material.

In the context of the present disclosure, the term “metal-rich” refers to a material having a metal content of at least 50% by weight, advantageously at least 60% by weight, advantageously at least 65% by weight, at least 70% by weight, at least 75% by weight, or at least 80% by weight. Metals can occur in the particulate materials described herein in their elemental form, as metal oxides, metal sulfides or as salts. The metal content is determined on the basis of chemical elements classified as metals, and which are referred to hereinafter as metal elements. In determining the metal content, only the atomic mass of the metal elements themselves are to be taken into account. The metal content is advantageously not determined on the basis of the molecular mass of the metal oxides, metal sulfides, or metal salts, but only taking the mass of the metal elements within these oxides, sulfides and salts into account. By way of example, if the metal-rich particulate material would comprise a metal oxide defined by the formula MₓO_{y}, then for determining the metal content, only a mass equal to x times the atomic mass of the metal element M would be taken into account.

Metal-rich fines or dusts are generated as waste or side streams in metallurgy and metalworking processes. Non-limiting examples are metallic by-products and waste materials derived from (metal) ore processing and metal refinery, (waste) metal abrasives, such as blasting grit, in particular steel abrasives, such as steel shot and steel grit, and metalworking chips or swarfs generated during machining of metal workpieces, such as turning and grinding.

In the context of the present disclosure, metal elements advantageously refer to one or a combination of elements identified as transition metals and post-transition metals in the periodic table of elements. Transition metals are those chemical elements listed in group 3 through 12 and period 4 through 6 of the periodic table of elements. Post-transition metals are listed in group 14 through 15 and period 3 through 6 of the periodic table of elements. A metal can refer to any one or a combination of the following elements: aluminium (Al), scandium (Sc), titanium (Ti), vanadium (V), chromium (Cr), manganese (Mn), iron (Fe), cobalt (Co), nickel (Ni), copper (Cu), zinc (Zn), gallium (Ga), yttrium (Y), zirconium (Zr), niobium (Nb), molybdenum (Mo), technetium (Tc), ruthenium (Ru), rhodium (Rh), palladium (Pd), silver (Ag), cadmium (Cd), indium (In), tin (Sn), hafnium (Hf), tantalum (Ta), tungsten (W), rhenium (Re), osmium (Os), iridium (Ir), platinum (Pt), gold (Au), mercury (Hg), thallium (Tl), lead (Pb), and bismuth (Bi). Of these, Al, Ti, V, Cr, Mn, Fe, Co, Ni, Cu, Zn, Ag, Sn, W, Pt, Au and Pb are preferred. Most preferred are Al, Ti, Fe, Cu, Zn, Ag, Pt, Au and Pb.

A major fraction of the metal-rich particulate material consists of inorganic compounds. Advantageously, the metal-rich particulate material comprises at most 10% by weight solid organic compounds, such as polymers, in particular synthetic polymers. The amount of organic compounds in the metal-rich particulate material is advantageously at most 8% by weight, advantageously at most 5% by weight, advantageously at most 3% by weight. The amount of organic compounds can be determined by thermogravimetric analysis on a dry matter basis. Advantageously, any one of the total carbon content and the total organic carbon content of the metal-rich particulate material is at most 5% by weight, advantageously at most 3% by weight, advantageously at most 2% by weight, advantageously at most 1% by weight. Total carbon (TC) can be measured by infrared detection after incineration. Total organic carbon content (TOC) can be determined as the difference between total carbon (TC) and total inorganic carbon (TIC) measured by infrared detection after acid hydrolysis.

The particle size and particle size distribution of the metal-rich particulate material (metal-rich dusts or fines) is not particularly critical. Advantageously, the metal-rich particulate material has a particle size distribution with 90^{th} percentile particle size (d₉₀) equal to or smaller than 10 mm. Advantageously, d₉₀ is equal to or smaller than 6 mm, equal to or smaller than 5 mm, or equal to or smaller than 3 mm. Advantageously, d₉₀ is at least 1 μm, or at least 10 μm. In addition or alternatively, the 50^{th} percentile particle size (d₅₀) advantageously falls between 0.1 μm and 5 mm. Particle size distributions refer to those obtained through laser diffraction, e.g. as obtained with a Malvern Mastersizer X type apparatus, and are typically determined on volumetric basis. If the metal-rich material would be too coarse, it can be granulated to a suitable grain size prior to being introduced in the above mixture.

The metal-rich particulate material is advantageously an iron-rich particulate material. Iron can be present in the particulate material in its elemental form, as an oxide, as a sulfide, or as a salt.

Powder coating is a dry powder paint technology that allows the coating of a wide variety of substrates, in particular, though not limited to, metal substrates. Powder coating waste is generated in different ways. Waste powder is generated during the powder coating process. Due to the overspray of fines and the lack of recuperation methods for multicolor systems, it is estimated that about 15% of the applied powder coating goes to waste. In addition, the production of powder coatings also yields production waste material. This waste material includes old stocks and off-spec powder coatings and amounts to 1-4% of the total powder coating production. The processing of this non-uniform waste material is quite costly to the industry. Indeed it requires selective collection by specialized firms which typically dispose of it as land fill.

Alternative uses of waste powder coating materials have been developed, such as melting the resin as raw material for plastic parts, using it as material for carpet padding and floor boards or as an additive to cement. However, none of these uses appear to have penetrated the market yet and powder coating waste is still mainly incinerated or landfilled. Accordingly, there is a need in the art for a reduced cost of waste powder coating handling as well as a simpler and more efficient processing method of waste powder coating material.

The waste powder coating material is a particulate material and typically comprises organic compounds, such as one or more synthetic polymers, in particular thermosetting polymers. Advantageously, organic compounds in the waste powder coating material, in particular the synthetic polymers, are present in an amount of at least 50%, advantageously at least 55% by weight, advantageously at least 60% by weight, advantageously at least 65% by weight. The waste powder coating material advantageously comprises a limited amount of inorganic compounds, if any. Possible inorganic compounds may be pigments, such as TiO₂. The waste powder coating material may therefore originate from a pigmented powder coating material, or alternatively from a powder clear coat. The amount of inorganic compounds can be determined by the residue after heating to 1000° C. The waste powder coating material advantageously shows a mass loss of at least 55% by weight, advantageously at least 60% by weight, advantageously at least 65% by weight upon heating to 1000° C. In other words, the residue upon heating to 1000° C. is at most 45%, 40%, or 35% by weight respectively on a dry initial matter basis.

The glass transition temperature, melting point and curing temperature of the powder coating (synthetic) polymers can vary over relatively wide ranges. Typical values for the glass transition temperature (T_{g}) may be between 30° C. and 60° C., in particular between 40° C. and 50° C. In addition, or alternatively, the powder coating polymers typically have a melting point between 50° C. and 90° C., in particular between 60° C. and 80° C., in particular between 70° C. and 80° C. The powder coating polymers are advantageously curable under suitable conditions, such as between 50° C. and 300° C., in particular between 80° C. and 260° C., in particular between 90° C. and 240° C. Alternatively, curing can be effected via a chemical reaction or by electromagnetic, e.g. ultraviolet, irradiation. Suitable types of thermosetting powder coating polymers are epoxy polymers, polyesters, acrylic polymers, polyurethanes and their hybrids, such as epoxy-polyesters. The waste powder coating material can comprise a mixture of polymers, differing in chemical structure, and, optionally, finely grained inorganic material, such as dust and/or pigments.

The waste powder coating material advantageously has a particle size distribution having a 90^{th} percentile particle size (d₉₀, 90% of the particles are below this value) equal to or smaller than 4 mm, advantageously equal to or smaller than 2 mm, advantageously equal to or smaller than 1 mm, advantageously equal to or smaller than 500 μm, advantageously equal to or smaller than 250 μm. The d₉₀ is advantageously at least 1 μm. In addition, or alternatively, the 50^{th} percentile particle size (d₅₀, 50% of the particles are below this value) is advantageously between 0.1 μm and 250 μm, advantageously between 1 μm and 150 μm, advantageously between 5 μm and 150 μm, advantageously between 5 μm and 100 μm.

It will be advantageous to use finer waste powder coating materials, since these allow for obtaining composite briquettes of equal compressive strengths with a lower amount of waste powder coating material, as compared to coarser waste powder coating materials. According to an aspect, the waste powder coating material is granulated to a desirable grain size as indicated above prior to being mixed with the metal-rich powder or granulated material, e.g. by known granulation techniques.

The total amount of the waste powder coating material in the above mixture, calculated on a dry matter basis, is at most 15% by weight, advantageously at most 12% by weight, advantageously at most 10% by weight, advantageously at most 8% by weight. The total amount of the waste powder coating material in the dry mixture is advantageously at least 0.1% by weight, advantageously at least 0.5% by weight, advantageously at least 1% by weight. Lower concentrations of waste powder coating material are advantageously used as they are available in relatively limited quantities, as compared to the metal-rich particulate material. Furthermore, with limited amounts of such waste powder coating materials, larger amounts of metal-rich powder and granular materials can be processed, while still obtaining sufficiently firm compacts.

The mixture advantageously consists of the metal-rich particulate material and of the waste powder coating material, on the basis of dry solids content. No other solids are advantageously present or added. The metal content of the mixture is advantageously at least 45%, with values of at least 50%, at least 55%, at least 60%, at least 65% by weight on a dry matter basis being particularly advantageous.

The mixing step is typically performed by a mixing device, such as a mixer or blender, including but not limited to a paddle mixer, a ribbon blender, or an Eirich mixer. All these mixing devices are known. Advantageously, the waste powder coating material is maintained in the solid state during the mixing step. Hence, mixing is advantageously carried out at a temperature below the melting point of the powder coating polymers, so as to prevent melting thereof during mixing. During mixing, the temperature of the mixture advantageously remains below 80° C., advantageously below 70° C., advantageously below 60° C., advantageously below 50° C. Mixing is advantageously performed at room temperature. The obtained mixture is a particulate material comprising individual particles of the metal-rich particulate material and individual particles of the waste powder coating material. The particles of the metal-rich particulate material in the mixture are therefore advantageously not coated with a polymer material.

In a subsequent step, the mixture is compacted to obtain a (composite) compact. The compacting step may include shaping the mixture, such as in a mould. The compacting step advantageously comprises applying a compaction pressure on the (moulded) mixture of at least 1 MPa, advantageously at least 2.5 MPa, at least 5 MPa or at least 10 MPa in order to obtain the compact. At the above compaction pressures, the powder coating particles can undergo plastic deformation and thereby increase the green strength of the compact. The duration of compacting, such as at the above indicated pressures, is advantageously less than 1 min, such as less than 30 s, less than 20 s, and may last less than 10 s, or even less than 5 s. To apply the above compaction pressure, a hydraulic or mechanical press, e.g. a screw press or roll-press, is advantageously used. Such presses are known and are employed in e.g. briquetting machines.

In order to ease compaction of the mixture, and/or to yield a minimum green strength of the compact, a liquid, in particular water, or another solvent, e.g. an organic solvent, may be added to the mixture prior to the shaping/compacting step. The liquid is added to the mixture in an amount between 1% and 10% by weight on the basis of the total weight of the dry mixture, advantageously the liquid is added in an amount between 2% and 8% by weight, advantageously between 3% and 5% by weight. Typically, an amount of liquid about equal to the amount of waste powder coating material is added to the mixture, e.g. the amount of liquid is between 50% and 150% by weight of the amount of waste powder coating material in the mixture, advantageously between 75% and 125% by weight.

The shape of the compacted composites into which the composite mixture is compacted is not critical. The shape of the compacts may be e.g. ovoid, cylindrical or prismatic with polygonal base. The compacts are advantageously compressed to an individual size of between 1 cm³ and 10 dm³, advantageously in the range between 5 cm³ and 5 dm³.

In most cases, the compact will have a green strength sufficient for individual handling, but typically this strength will not be sufficient for bulk handling. In a further aspect, the compact is subjected to a curing step which converts the compact into a composite briquette. The curing of the compacts increases the strength of the compact. Curing can be performed by any suitable method to cure (thermosetting) polymers, such as by heat, by irradiation and/or by catalysts. Advantageously, the compact is cured by heat at a temperature between 50° C. and 300° C., such as between 80° C. and 260° C., between 110° C. and 240° C., or between 120° C. and 220° C. to obtain the briquette. At these temperatures, the synthetic (thermosetting) polymers in the waste powder coating material will melt and form a binding phase between the particles of the metal-rich particulate material. Curing can be carried out in an oven, or a dryer, such as a belt dryer. The curing step can be carried out as a batch process, or as a continuous process. It is understood that for economic reasons, a lower temperature is usually preferred. The heat curing is advantageously performed using waste heat. Waste heat relates to the so-called “low-grade” heat as a by-product of high temperature processes or the operation of e.g. heat engines.

A major advantage of using waste powder coating materials as binder is the relatively short processing time to cure the compacts and gain final strength. The curing time is advantageously at least 10 min, advantageously at least 30 min, at least 60 min. Advantageously, the curing time, e.g. at the indicated temperatures, is 6 hours or less, advantageously 4 hours or less. It is understood that longer curing times are needed at lower curing temperatures for (fully) curing the compact. Particularly suitable curing conditions correspond to a curing temperature of between 120° C. and 150° C. for a curing time of at least 1 or 2 hours, such as a curing temperature of about 120° C.-130° C. and a curing time of about 2.5 hours.

Curing times and curing temperatures may correspond to the times and temperatures indicated by the (original) manufacturer of the powder coating material.

The compressive strength of the composite briquette advantageously ranges between 1 and 50 MPa. The compressive strength is advantageously at least 2 MPa, advantageously at least 3 MPa, advantageously at least 4 MPa and advantageously between 5 MPa and 40 MPa. In certain embodiments, the curing conditions are adapted to obtain a fully cured compact. In other embodiments, the curing conditions are adapted to obtain a partially cured compact. It is understood that a compact is fully cured when no curing transition can be seen upon DSC analysis of the compact, while a curing transition can be detected by DSC analysis upon partial curing of the compact.

According to an aspect, the composite briquette comprises a binding phase and a dispersed phase. The binding phase or matrix comprises, or consists of, cured waste powder coating material, and is advantageously a cured thermosetting polymer phase extending between particles of the metal-rich particulate material, which forms a dispersed phase. It will be convenient to note that due to the low curing temperatures of the compacts, the metal-rich particulate material, mainly made up of inorganic compounds, will generally retain its original chemical composition as indicated above. The weight fraction of the binding phase to the total mass of the composite briquette can be determined by thermogravimetric analysis (organic fraction) and advantageously amounts to 15% or less, advantageously to 10% or less, advantageously to 8% or less, advantageously to 6% or less. The weight fraction of the binding phase can be at least 1%, at least 2%, or at least 3%.

A possible application of the composite briquettes is its use as a bulk secondary ore material. The composite briquettes have suitable dimensions and have a sufficiently high metal content for being introduced in a smelting oven or furnace for making metals. These ovens are typically operated at temperatures of 650° C. or higher, such as temperatures of 850° C., 1000° C., or 1150° C. or higher. The composite briquette will decompose in the oven. In particular, the polymer fraction, mainly originating from the waste powder coating material will be completely combusted and provides additional energy. A typical caloric value of powder coating material is between 35 and 40 MJ/kg. A major part of the metal containing compounds and particles, such as metal oxides, sulfides, salts and elemental metals, mainly originating from the metal-rich particulate material, will melt and contribute to the metal melt in the oven. A smaller part of inorganic material, originating from e.g. dust, may transfer to the slag fraction in the oven. A particular example is the recycling of iron-rich fines, such as steel grit and steel chips in steel or cast iron production.

One advantage of the composite compacts and briquettes according to aspects described herein, is that they make multiple waste streams and side streams economically valuable by turning them into a composite article having economical value. Advantageously, the composite compacts and briquettes described herein can be entirely made of waste materials.

### Examples

### Example 1: Particle Size of Powder Coating Waste (PCW) Materials

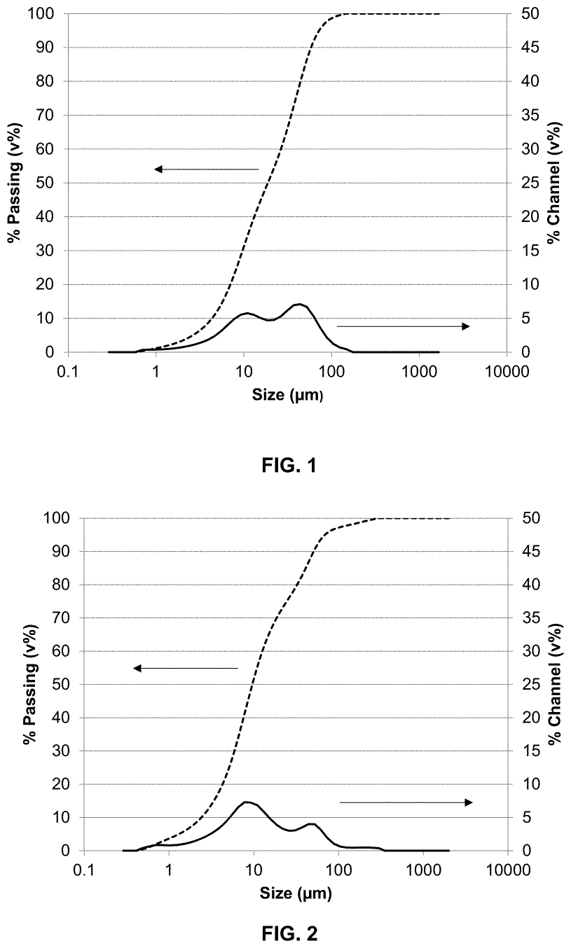

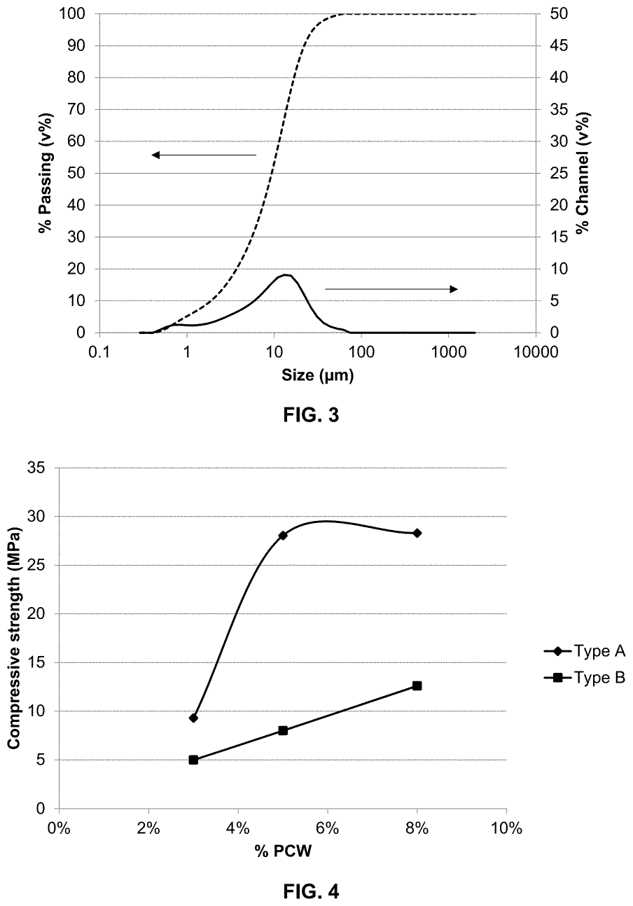

The particle size distribution of the powder coating wastes was determined using laser diffraction (300 μm lens, Malvern Mastersizer X long bed). The particle-size results for polyester, epoxy-polyester and epoxy powder coating waste materials are respectively given in FIG. 1, FIG. 2 and FIG. 3.

FIG. 1 shows that the polyester powder coating waste is finely divided. The upper particle size limit of the powder is ca. 100 μm. From the particle size distribution histogram (FIG. 1) it is derived that there are two dominant particle sizes: 10 μm and 45 μm. The 50^{th} percentile grain size (d₅₀) is 19 μm.

FIG. 2 shows that the epoxy-polyester powder coating waste is finely divided. The upper particle size limit of the powder is ca. 100 μm (same as for polyester). From the particle size distribution histogram (FIG. 1) it is derived that there are dominant two particle sizes: 10 μm and 50 μm. The 50^{th} percentile grain size (d₅₀) is 9.6 μm.

FIG. 3 shows that the epoxy powder coating waste is finely divided. The upper particle size limit of the powder is ca. 100 μm (same as for polyester and epoxy-polyester). From the particle size distribution histogram (FIG. 3) it is derived that there is one dominant particle size: 13 μm. The 50^{th} percentile grain size (d₅₀) is 9.3 μm.

### Example 2: Thermal Analysis of Powder Coating Waste Materials

The powder coating wastes are thermally analyzed by performing a thermogravimetric analysis (TGA) combined with differential scanning calorimetry (DSC). TGA measurements were performed by the Netzsch STA 449C apparatus, under a normal atmosphere (air) and at a rate of 10K/min. For the polyester, epoxy-polyester and epoxy powder coating waste materials, it was observed that between 400° C. and 500° C. the thermoset polymer decomposes (mass loss in TGA and exothermic peak in DSC).

For the epoxy powder coating waste sample, the DSC measurements were performed with a modulated MDSC TA-Instruments 2920 at a heating rate of 10K/min. Prior to the measurement, the powder coating waste was heated to 90° C. and then cooled down to ambient temperature. At the temperature of 46° C. a first drop is noticed in the DSC line, which corresponds to the softening temperature or glass transition temperature T_{g}, where the powder coating waste turns ‘soft’ and allows viscoelastic deformation. At about 65° C. a second peak is noticed. This peak corresponds to the melting point of the uncured epoxy. The powder coating waste thus is a semi-crystalline polymer wherein the amorphous portion exhibits a glass transition, and the crystalline portion undergoes a melting process.

On further heating of the sample beyond its melting point, the powder coating waste will start to flow. On still further heating, the curve reveals a transition indicating that the powder starts to cure (Toc—curing onset temperature). This occurred at 124° C. for the epoxy powder sample. On still further heating, one principal exothermic was observed corresponding to curing reactions, with a maximum rate of heat evolution at 183° C. At the temperature of ca. 230° C. the exothermic peak drops, showing the completion of the curing reactions. Curing of the epoxy powder coating waste material thus takes place between approximately 124° C. and terminates at about 230° C.

To check the duration of the curing process at a fixed temperature, yet another DSC experiment was performed. In this case the temperature of the experiment was increased to 180° C. (maximum curing rate) and held there for 30 minutes. The heat flow during the experiment was measured. Under these conditions, the curing was completed after about 10 min as the heat flow drops to a constant value. The thermosetting behavior of the epoxy powder coating waste material was confirmed by reheating the cured epoxy waste to 90° C. and analyzing the heat flow by DSC. No melting of the cured epoxy powder coating waste material could be observed.

Chemical analysis of the powder coating waste material showed that it mainly comprises of polymeric material (analyzed as organic carbon content). However, after heating the powder coating waste up to 1000° C. (above the decomposition temperature of the polymer), still some residue was left. For all PCW material tested (epoxy, polyester or epoxy-polyester) XRF analysis of the residue showed the presence of dust-related elements (Ca, Al, Si, Mg, etc), but also the presence of pigment related elements, particularly Ti (TiO₂ is a widely used white colored pigment). This shows that powder coating waste material is not a uniform and pure polymeric material, but may contain significant levels (e.g. about 20-35 wt %) of inorganic materials (dust, pigments) as well.

### Example 3: Composite Briquette Made of Coarse Steel Blasting Grit

Waste blasting grit (steel) having a d₉₀=1 mm and Fe content of 88% by weight (referred to as Grit type A) was used as the metal-rich granular material and mixed with epoxy-polyester powder coating waste material of Example 1. Mixtures with 3% by weight, 5% by weight and 8% by weight of powder coating waste material (on dry matter) were made. In these mixtures, the weight fraction of the Grit type A material was 97%, 95% and 92% respectively. The mixtures were all shaped in a mold and compacted with a compaction pressure of 10 MPa to obtain cylindrical compacts of 40 mm diameter and 17 mm thickness. No water was added. The compacts were subsequently cured in an oven at a temperature of 120° C. for 2.5 hours to obtain composite briquettes. The curing time of 2.5 hours was determined by curing samples for different time spans and determining the compressive strength. It was observed that after about 2 hours of curing at 120° C., the compressive strength did not increase any more, indicating full cure after this time span. A microscope image of the briquette obtained via the above procedure with 5% wt powder coating waste is shown in FIG. 5.

The composite briquettes were tested for their compressive strength and the results are shown in FIG. 4. There is a stark increase in compressive strength of the briquettes when increasing the amount of powder coating waste material from 3% to 5% by weight from about 9 MPa to about 28 MPa respectively. The compressive strength of the briquette appears to remain stable when the amount of powder coating waste material is further increased to 8%.

### Example 4: Composite Briquette Made of Fine Steel Grit

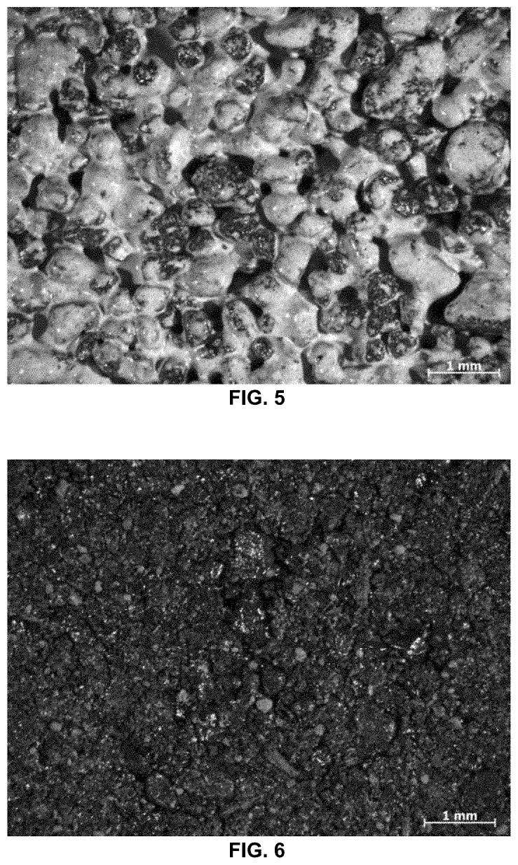

The procedure of Example 3 is repeated with waste blasting (steel) grit having a d₉₀=250 μm and Fe content of 52% by weight (referred to as Grit type B) as the metal-rich granular material. A microscope image of a briquette with 5% wt powder coating waste is shown in FIG. 6.

FIG. 4 shows the results of compressive strength of the composite briquettes obtained with Grit type B. It is noticed that the compressive strength is roughly half of the compressive strength of the briquettes obtained in Example 3. The compressive strength increases quite linearly from 5 MPa for briquettes with 3% by weight powder coating waste material, through about 8 MPa for briquettes with 5% by weight powder coating waste material, to about 13 MPa for briquettes with 8% by weight powder coating waste material.

Comparison between FIGS. 5 and 6 explains why the briquettes with Grit type A are stronger in comparison with those with Grit type B. The particle size of Grit type A is larger, resulting in a good bond between the different particles (given the amount of powder coating waste, i.c. 5%). In the case of the briquettes with Grit type B, the compressive strength is lower because there is much less physical bonding between the particles as the particles are much finer and greater in number. To achieve higher strength briquettes with Grit type B, more powder coating waste should be added to form a much denser or much more interconnected matrix.

### Example 5: Integrity of the Composite Briquettes

Following iron-rich waste materials were used:
Polysius SG
Mill scale
Fe—Si dust
Pig iron fines with particle size (0-5 mm)
Oily mill scale (polluted with mineral oil), and
Red oxide powder (polluted with chloride).

With each one of the above iron-rich waste materials composite briquettes were made by mixing the iron-rich waste materials with waste epoxy powder coating material in a proportion 95% wt. iron-rich waste material and 5% wt. waste epoxy powder coating material. The iron-rich waste materials had a moisture content between 0 and 15% by mass. In some cases, the materials were dried to reduce the moisture content to 15%. Mixing was performed in an Eirich mixer type R01 with capacity 3-5 liters. The cup speed and rotor speed were set to 0.5 m/s and 5 m/s respectively and intensive mixing was performed for 60 s. The mixture was subsequently shaped in a MEYER press using a press force of 100 kg/cm² to make briquettes with 43 mm diameter and 30-50 mm height. A small quantity of water (5% by mass) was added to facilitate shaping in the press.

The green briquettes were subsequently hardened (cured) in an oven at 160° C. The briquettes retained their shape. In order to test physical integrity of the samples, a batch of each of them was subjected to a second thermal treatment at 400° C. Compressive strength of the original hardened briquettes (at 160° C.) and the thermally treated briquettes (at 400° C.) is indicated in Table 1.

TABLE 1
Compressive strength (MPa) of the composite
briquettes following hardening (160°
C.) and thermal treatment (400° C.).

| | Curing | Thermal treatment |
|---|---|---|
| Compressive strength (MPa) | 160° C. | 400° C. |
| Polysius SG | 6.2 | 0.55 |
| Mill scale | 22.0 | 3.6 |
| Fe—Si dust | 19.7 | 13.04 |
| Pig iron fines | 12.8 | 7.4 |
| Red oxide | 5.5 | / |
| Oily mill scale | 4.0 | / |

The thermal treatment at 400° C. reduces the compressive strength, probably due to disintegration of the epoxy binder. However, for some briquettes a compressive strength higher than 1 MPa can still be obtained.

### Example 6: Drop Tests

The briquettes obtained from example 5 were also screened in drop tests from a height of 2 m. Results are shown in Table 2. All hardened briquettes remained intact. However, some of the thermally treated briquettes showed damages.

TABLE 3
Results of drop tests of composite briquettes (obtained
from Example 4 following hardening (160°
C.) and thermal treatment (400° C.).

| | Curing | Thermal treatment |
|---|---|---|
| Drop test 2 m | 160° C. | 400° C. |
| Polysius SG | intact | crushed |
| Mill scale | intact | limited damage |
| Fe—Si dust | intact | intact |
| Pig iron fines | intact | intact |
| Red oxide | intact | limited damage |
| Oily mill scale | intact | limited damage |

### Example 7: Briquettes Made with a Roller Press

The feasibility of shaping the briquettes in a roller press, with lower press force applied compared to a hydraulic press, was investigated. Different kinds of waste powder coating materials (epoxy, epoxy-polyester and polyester) were added to LD slag to obtain different samples. A mixing ratio of 95% wt LD slag and 5% wt waste powder coating was used. For the epoxy waste, a mixing ratio of 97% wt LD slag and 3% wt waste powder coating was also tested. The mixing and curing procedures were same as in example 5, only the shaping step differed. For shaping a roller Euragglo briquetting compactor was used. Drop tests from 2 m height were performed on the obtained briquettes, and all briquettes (hardened at 160° C.) remained intact.

The following series of paragraphs is presented without limitation to describe additional aspects and features of the disclosure:

A0. Method of making a composite compact or briquette, comprising: mixing a first particulate material with a waste powder coating material to obtain a mixture, the amount of the waste powder coating material in the mixture being 15% or less by weight, and

compacting the mixture into a compact,

characterized in that the first particulate material has a metal content of at least 50% by weight.

A1. Method of A0, further comprising curing the compact at a temperature between 50° C. and 300° C. to obtain the composite briquette.

A2. Method of A0 or A1, comprising adding between 0.1% and 10% by weight of water to the mixture.

A3. Method of any one of paragraphs A0 through A2, wherein the mixture is compacted with a pressure of at least 1 MPa.

A4. Method of any one of paragraphs A0 through A3, wherein the first particulate material comprises an element selected from the group consisting of Al, Sc, Ti, V, Cr, Mn, Fe, Co, Ni, Cu, Zn, Ga, Y, Zr, Nb, Mo, Tc, Ru, Rh, Pd, Ag, Cd, In, Sn, Hf, Ta, W, Re, Os, Ir, Pt, Au, Hg, Tl, Pb, Bi and combinations thereof in an amount of at least 50% by weight.

A5. Method of any one of paragraphs A0 through A4, wherein the first particulate material has a metal content of at least 65% by weight, and the mixture has a metal content of at least 60% by weight on a dry matter basis.

A6. Method of A5, wherein the metal content refers to iron content.

A7. Method of any one of paragraphs A0 through A6, wherein the first particulate material is a waste material of metal ore processing and/or metalworking.

A8. Method of any one of paragraphs A0 through A7, wherein the first particulate material is waste metal blasting grit, in particular waste steel blasting grit.

A9. Method of any one of paragraphs A0 through A8, wherein the waste powder coating material comprises at least 50% by weight thermosetting polymer compounds.

A10. Method of A9, wherein the thermosetting polymer compounds comprises one or a combination of: epoxy polymers, polyesters, acrylic polymers, polyurethanes and hybrids thereof.

A11. Method of A9 or A10, wherein the waste powder coating material comprises a pigment.

A12. Method of any one of paragraphs A0 through A11, wherein the waste powder coating material has a particle size distribution having a 90 percentile particle diameter smaller than or equal to 4 mm.

A13. Method of any one of paragraphs A0 through A12, wherein the waste powder coating material has a particle size distribution having a 50 percentile particle diameter between 0.1 μm and 250 μm.

A14. Method of any one of paragraphs A0 through A13, wherein the amount of the waste powder coating material in the mixture is 8% by weight or less.

B0. Composite briquette, comprising:
a binding phase formed of a cured waste powder coating material, and
a dispersed phase formed of a particulate material having a metal content of at least 50% by weight,
wherein the binding phase amounts to at most 15% by weight of the briquette.

B1. Composite briquette of B0, having a metal content of at least 60% by weight.

B2. Composite briquette of B0 or B1, wherein the binding phase amounts to between 2% and 10% by weight and having a compressive strength between 5 MPa and 50 MPa.

C0. Use of the composite briquette obtained by the method of any one of paragraphs A0 to A14, or the composite briquette of any one of paragraphs B0 to B2, as a secondary ore material.

C1. Use according to C0, comprising introducing the composite briquette into a smelting oven and obtaining a metal therefrom.

1. A method of making a composite briquette, comprising:
mixing a first particulate material with a waste powder coating material to obtain a mixture, the waste powder coating material in the mixture being 15% or less by weight; and
compacting the mixture into a briquette; and
curing the briquette at a temperature between 50° C. and 300° C.;
wherein the first particulate material has a metal content of at least 50% by weight;
wherein the first particulate material has a particle size distribution having a 90th percentile particle diameter between 10 μm and 5 mm; and
wherein the waste powder coating material comprises at least 50% by weight thermosetting polymer compounds.

2. (canceled)

3. The method of claim 1, further comprising adding between 0.1% and 10% by weight of water to the mixture.

4. The method of claim 1, wherein the mixture is compacted with a pressure of at least 1 M Pa.

5. The method of claim 1, wherein the first particulate material comprises an element selected from the group consisting of Al, Sc, Ti, V, Cr, Mn, Fe, Co, Ni, Cu, Zn, Ga, Y, Zr, Nb, Mo, Tc, Ru, Rh, Pd, Ag, Cd, In, Sn, Hf, Ta, W, Re, Os, Ir, Pt, Au, Hg, Tl, Pb, Bi, and combinations thereof in an amount of at least 50% by weight.

6. The method of claim 1, wherein the first particulate material has a metal content of at least 65% by weight, and the mixture has a metal content of at least 60% by weight on a dry matter basis.

7. The method of claim 6, wherein the metal content refers to iron content.

8. The method of claim 1, wherein the first particulate material is a waste material of one or a combination of metal ore processing and metalworking.

9. The method of claim 1, wherein the first particulate material is waste metal blasting grit.

10. (canceled)

11. The method of claim 1, wherein the thermosetting polymer compounds comprise one or a combination of: epoxy polymers, polyesters, acrylic polymers, polyurethanes, and hybrids thereof.

12. The method of claim 1, wherein the waste powder coating material comprises a pigment.

13. The method of claim 1, wherein the waste powder coating material has a particle size distribution having a 90 percentile particle diameter smaller than or equal to 4 mm.

14. The method of claim 1, wherein the waste powder coating material has a particle size distribution having a 50 percentile particle diameter between 0.1 μm and 250 μm.

15. The method of claim 1, wherein the amount of the waste powder coating material in the mixture is 8% by weight or less.

16. A composite briquette, comprising:
a binding phase formed of a cured waste powder coating material; and
a dispersed phase formed of a particulate material having a metal content of at least 50% by weight;
wherein the binding phase amounts to at most 15% by weight of the briquette;
wherein the particulate material has a particle size distribution having a 90th percentile particle diameter between 10 μm and 5 mm; and
wherein the cured waste powder coating material comprises at least 50% by weight thermosetting polymer compounds.

17. The composite briquette of claim 16, having a metal content of at least 60% by weight.

18. The composite briquette of claim 16, wherein the binding phase amounts to between 2% and 10% by weight and having a compressive strength between 5 MPa and 50 MPa.

19. A method comprising:
obtaining a composite briquette by: mixing a first particulate material with a waste powder coating material to obtain a mixture, the waste powder coating material in the mixture being 15% or less by weight and comprising at least 50% by weight thermosetting polymer compounds;
compacting the mixture into a briquette;
curing the briquette at a temperature between 50° C. and 300° C.;
wherein the first particulate material has a metal content of at least 50% by weight and a particle size distribution having a 90th percentile particle diameter between 10 μm and 5 mm; and
using the composite briquette as a secondary ore material.

20. The method according to claim 19, further comprising introducing the composite briquette into a smelting oven and obtaining a metal therefrom.

21. The method of claim 1, wherein the first particulate material has a particle size distribution having a 90th percentile particle diameter between 500 μm and 10 mm.
